(19) United States
(12) Patent Application Publication
(10) Pub. No.: US 2025/0276851 A1
(43) Pub. Date: Sep. 4, 2025

(54) A CONTAINER HANDLER, A STORAGE AND RETRIEVAL SYSTEM COMPRISING THE CONTAINER HANDLER AND A METHOD FOR HANDLING A CONTAINER BY MEANS OF THE CONTAINER HANDLER

(71) Applicant: AutoStore Technology AS, Nedre Vats (NO)

(72) Inventors: Trond Austrheim, Etne (NO); Joakim Aleksander Myrbakken, Skudeneshavn (NO)

(21) Appl. No.: 18/861,799

(22) PCT Filed: Apr. 24, 2023
(86) PCT No.: PCT/EP2023/060578

§ 371 Date: Oct. 30, 2024

(30) Foreign Application Priority Data
May 3, 2022 (NO) 20220504

(51) Int. Cl. B65G 1/04; B65G 47/90

(52) U.S. Cl. CPC B65G 1/0464; B65G 47/902; B65G 47/907; B65G 2201/0258

(57) ABSTRACT

The invention concerns a container handler (2) for bidirectional transfer of containers (20, 106) between a port (205) of a storage grid (104) of an automated storage and retrieval system (1) and a conveyor (210) for transporting containers. The container handler (2) comprises an arm (215) having an axis of rotation (AR), an arm displacer (220), at least a first coupler (225a) provided at a first end of said arm (215), said first coupler (225a) for releasable engagement with a container (20, 106). The arm displacer (220) is configured to rotate the arm (215) about the axis of rotation (AR) with at least the first coupler (225a) held in a horizontal plane between a first and a second arm rotational position and displace the arm (215) with the first coupler (225a) in a vertical direction between a first and a second vertical position. The invention further concerns an automated storage and retrieval system (1) comprising the container handler (2) and a method for handling a container (20, 106) by means of the container handler (2).

### FIELD OF THE INVENTION

On a general level the present invention relates to a container handler and a storage and retrieval system comprising the container handler.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c. 301c, 401c is arranged to engage with two adjacent rails of the second set 111 of rails. At least one of the sets of wheels 201b, 201c, 301b, 301c, 401b, 401c can be lifted and lowered, so that the first set of wheels 201b. 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a for vertical transportation of storage containers 106, e.g. raising a storage container 106 from, and lowering a storage container 106 into, a storage column 105. Lifting bands 404a and guiding pins 405 are also shown in FIG. 3b. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference numbers 304 and 404. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as 40) storage cells within storage columns. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks: in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown in FIG. 2 but visible in FIGS. 3a and 3b), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing 20) storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at 30) the desired position. The removed storage containers 106 may then be lowered back into the storage column 105 or relocated to other storage columns 105.

For monitoring and controlling the automated storage and retrieval system 1. e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

To facilitate handling of product items stored in the storage container 106, the product items may be placed in a delivery container for subsequent placement in the storage container 106. In this way, the delivery container holding the product items may exit the automated storage and retrieval system 1, while the storage container 106 remains in the system 1.

One way of handling storage containers containing product items is disclosed in US2021229917A1. System of US2021229917A1 comprises a storage container transfer vehicle interacting with a storage container lift assembly comprising at least one movable lifting member. The vertically movable lifting member of the assembly is arranged to receive the storage container from said transfer vehicle.

A further way of handling storage containers containing product items is disclosed in EP3205606A1 featuring a combined area for container handling and storage.

An objective of the present invention is to provide a system and a method that allows handling of containers, for instance delivery containers placed in storage containers, or storage containers themselves in a time efficient and resource saving manner.

### SUMMARY OF THE INVENTION

The present invention is set forth and characterized in the independent claims, while the dependent claims describe other characteristics of the invention.

In a first aspect, the invention concerns a container handler for bidirectional transfer of containers between a port of a storage grid of an automated storage and retrieval system, and a conveyor for transporting containers, said container handler comprising:
an arm having an axis of rotation,
an arm displacer,
at least a first coupler provided at a first end of said arm, said first coupler for releasable engagement with a container,
wherein the arm displacer is configured to:
   rotate the arm about the axis of rotation with at least the first coupler held in a horizontal plane between a first and a second arm rotational position, and
   displace the arm with at least the first coupler in a vertical direction between a first and a second vertical position.

By providing a container handler in accordance with first aspect of the invention, a compact container handling solution having small footprint is achieved. In a related context, a constructionally simple container handler is achieved with only a few moving parts. This also results in a robust and reliable solution being considerably less expensive than prior art solutions, such as robotic arms. The constructional simplicity and robustness don't negatively impact the output capacity of the container handler.

Moreover, the container handler is versatile and may be employed in connection with different port types, such as conveyor ports, swing ports and carousel ports, and different conveyor types, such as roller conveyors and belt conveyors.

Another aspect of the invention relates to a method for handling a container in accordance with claim 24. For the sake of brevity, advantages discussed above in connection with the container handler may even be associated with the corresponding method and are not further discussed.

For the purposes of this application, the term “container handling vehicle” used in “Background and Prior Art”-section of the application and the term “remotely operated vehicle” used in “Detailed Description of the Invention”-section both define a robotic wheeled vehicle operating on a rail system arranged across the top of the framework structure being part of an automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

The following drawings depict exemplary embodiments of the present invention and are appended to facilitate the understanding of the invention. However, the features disclosed in the drawings are for illustrative purposes only and shall not be interpreted in a limiting sense.

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3a is a perspective view of a prior art container handling vehicle having a cantilever for carrying storage containers underneath.

FIG. 3b is a perspective view of a prior art container handling vehicle having an internally arranged cavity for carrying storage containers therein, wherein the cavity is offset from center relative to a principal direction.

FIG. 4 is a perspective view of a part of an exemplary automated storage and retrieval system according to the invention, comprising a container handler, a carousel-type port and a conveyor for transporting containers.

FIG. 5 is a perspective view of the container handler of FIG. 4.

FIGS. 6A-6F illustrate an operational sequence of the container handler of FIGS. 4 and 5.

FIG. 7 is a perspective view of a coupler of a container handler when in engagement with a container.

FIG. 8 is a perspective view of a container handler in accordance with an alternative embodiment.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

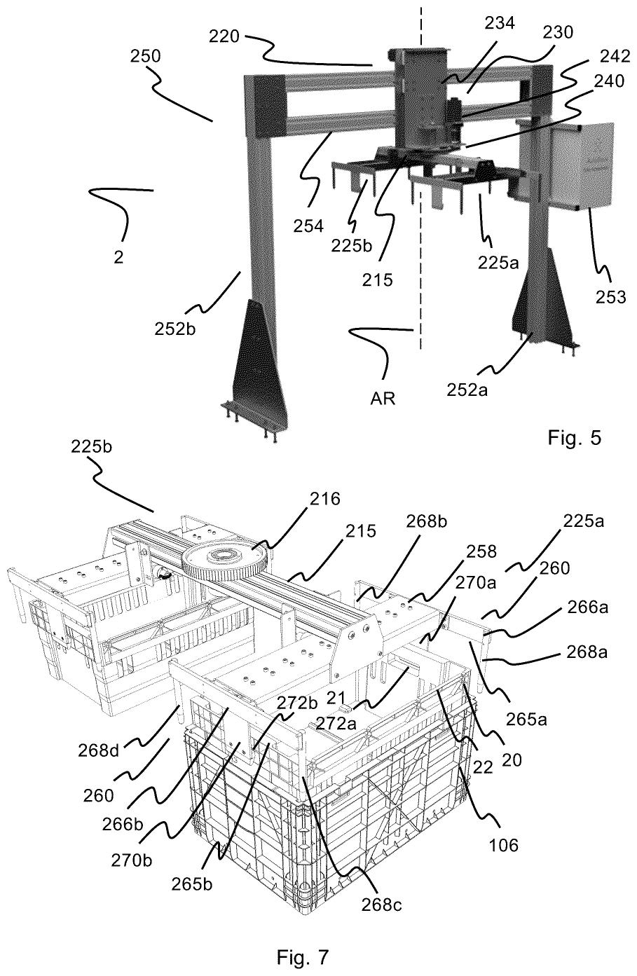

FIG. 4 is a perspective view of a part of an exemplary automated storage and retrieval system according to the invention, comprising a container handler 2, a carousel-type port 205 and a conveyor 210 for transporting containers.

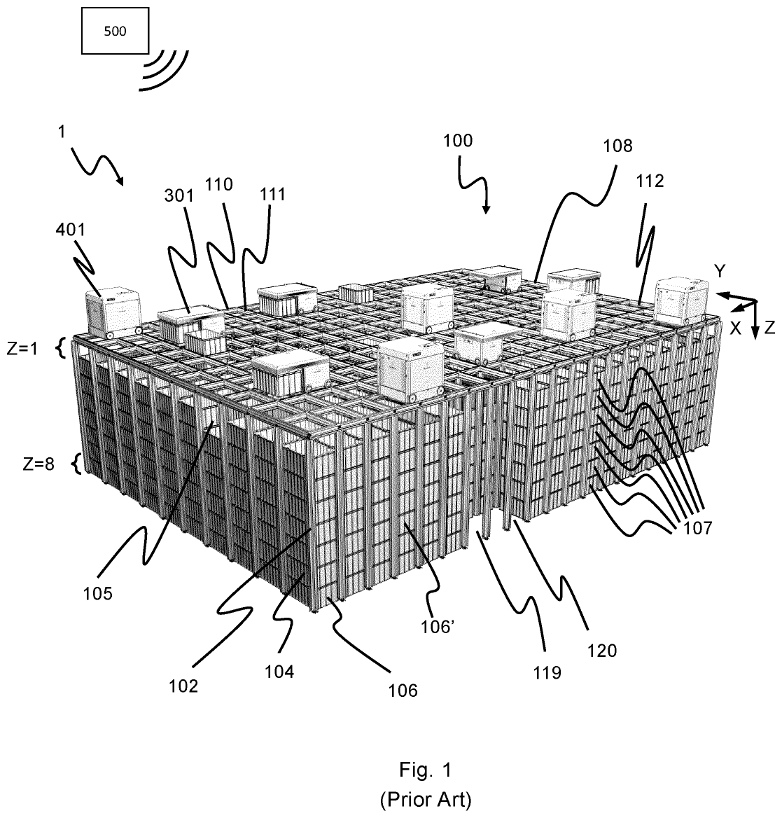

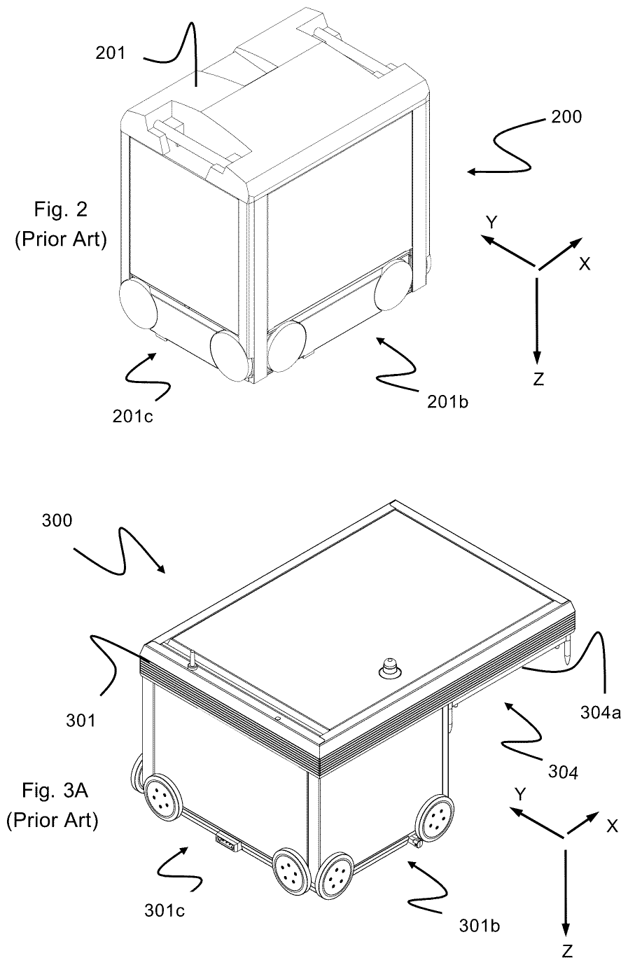

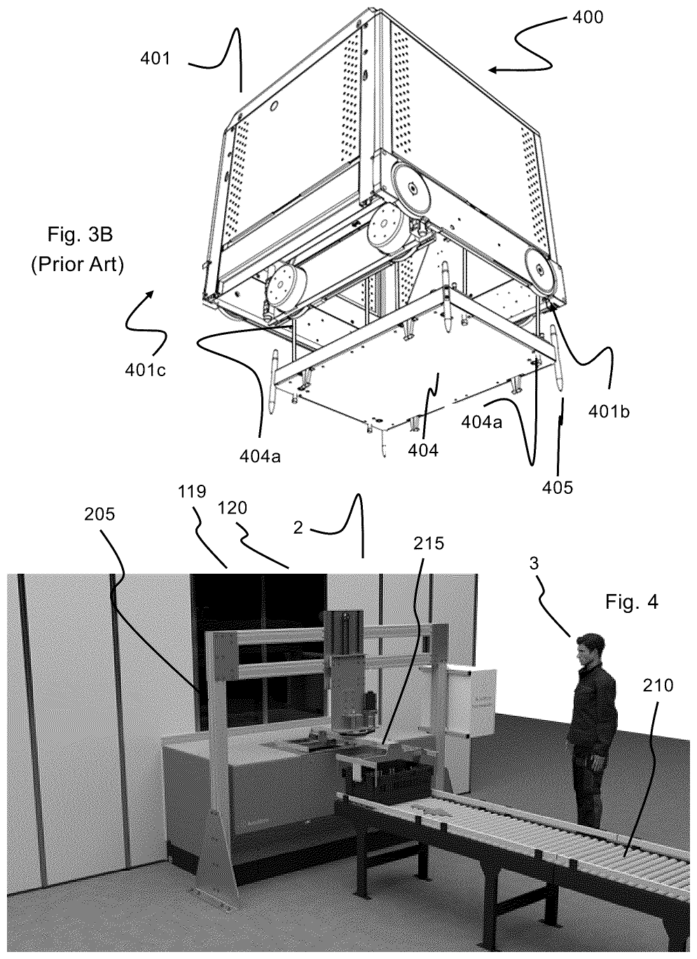

The system 1 of FIG. 4 is equal or similar to the prior art system of FIG. 1, i.e. it comprises a framework structure, a plurality of container handling vehicles moving in X and Y directions on a rail system constituting the topmost part of the framework structure. Each container handling vehicle comprises a lifting device configured to lift/lower a container from/onto a stack within a storage column and to lower/lift the container through any one of port columns 119, 120 and into the carousel port 205.

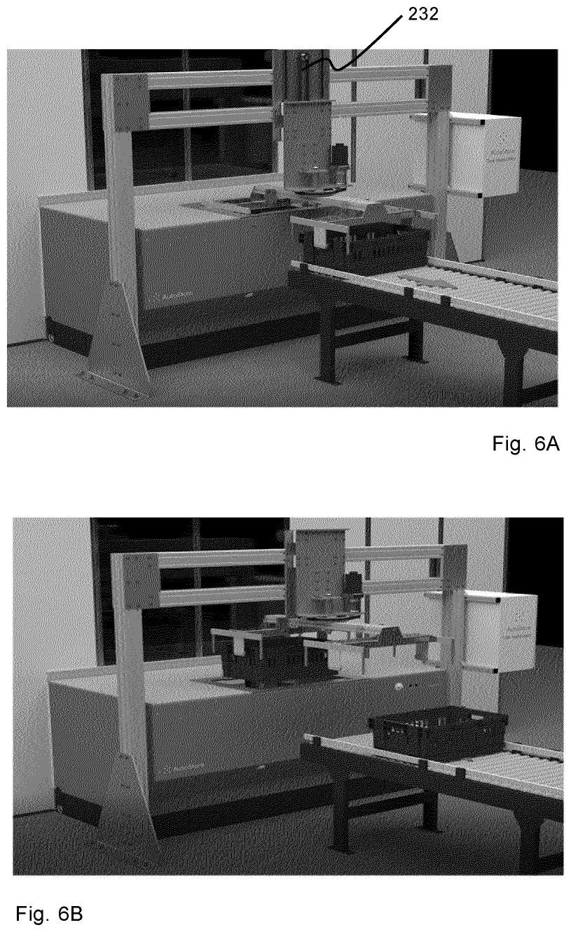

It is also shown a container handler operator 3, said container handler 2 for bidirectional transfer of containers between the port 205 of a storage grid of the automated storage and retrieval system 1 and a conveyor 210 for transporting containers, said conveyor 210 also being part of the system 1. Parts of the container handler 2 will be described in greater detail in connection with FIG. 5.

Turning back to FIG. 4, the container handler 2 is provided at an interface of the port 205 of the storage grid 104 of the automated storage and retrieval system 1 and the conveyor 210 for transporting containers.

Still with reference to FIG. 4, the conveyor 210 for transporting containers is suitably positioned with respect to the carousel port 205 such that the arm 215 of the container handler 2 may be aligned with a container tray (not visible in FIG. 4) of the port 205 of the storage grid 104 of the automated storage and retrieval system 1 and a longitudinal axis of the conveyor 210 for transporting containers.

In one preferred embodiment, the carousel port 205 rotates substantially concurrently with the displaceable arm 215. Furthermore, the carousel port 205 and the displaceable arm 215 are arranged to rotate in opposite directions. This facilitates container handoff between the carousel port 205 and the displaceable arm 215 of the container handler 2.

For the sake of structural simplicity of the handler 2, said container tray and the conveyor 210 of the system 1 are typically provided at the same level.

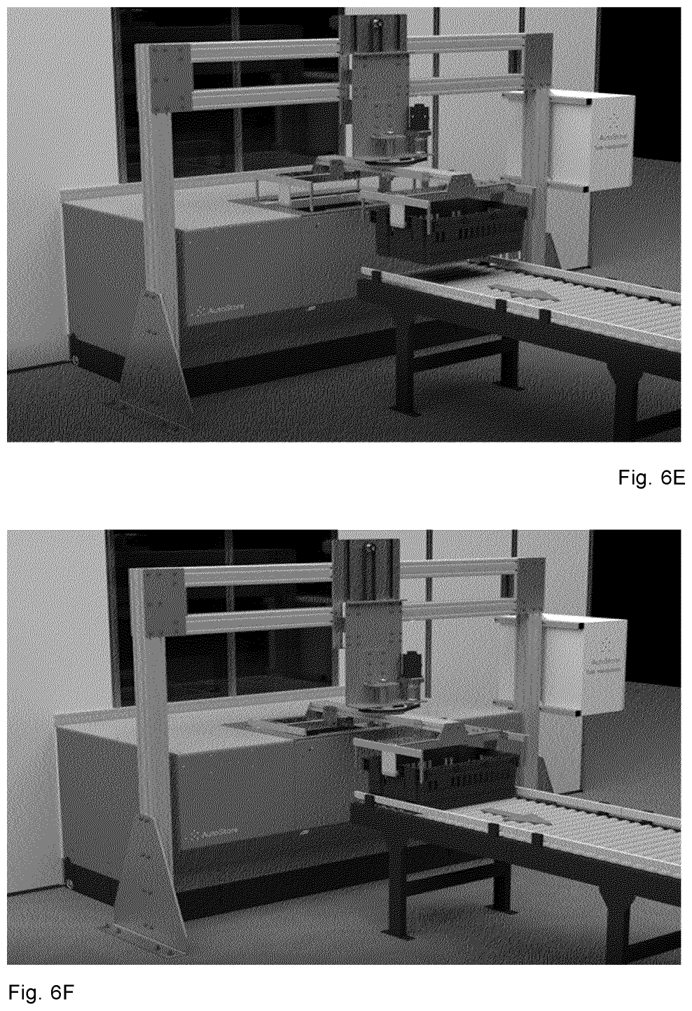

Still with reference to FIG. 4, the system 1 may include two types of containers, a delivery container (tote) and a storage container (bin: both shown and discussed in connection with FIG. 7. The relative sizes and designs of the totes and bins are such that at least one tote may be placed inside the bin. Each tote may contain one or more product items that may be handled by e.g. human and/or robotic operators. In addition to handling totes, the container handler 2 may handle, i.e. transfer, entire bins, holding either totes or loose product items.

When the container handler 2 and the conveyor 210 form part of the system 1 with a particular configuration of FIG. 4, an automated process may be achieved that allows retrieval and storing of containers in a highly efficient and resource saving manner. The automated process performed by the container handler 2 may be controlled by a dedicated control system or by a general control system also controlling the operation of the container handling vehicles, the carousel port 205 and the conveyor belt 210.

FIG. 5 is a perspective view of the container handler 2 of FIG. 4. As discussed in connection with FIG. 4, the container handler 2 is for bidirectional transfer of containers between a port of a storage grid of an automated storage and retrieval system and a transport conveyor. The container handler 2 comprises a stand 250. The stand has vertical, floor-supported pillars 252a, 252b interconnected by a pair of parallel horizontal crossbars 254, thereby creating a bridge shape under which the conveyor may pass (as shown in FIG. 4). The stand 250 straddles the port of the storage grid of the automated storage and retrieval system. The pillars 252a, 252b may be affixed to the floor by means of bolts. A control cabinet 253 is attached to one of the pillars 252a. Moreover, the container handler 2 comprises a horizontally extending arm 215 connected to the crossbar 254 and having an axis of rotation AR, an arm displacer 220, a first coupler 225a provided at a first end of said arm 215, said first coupler 225a for releasable engagement with a container (not shown in FIG. 5) and a second coupler 225b provided at a second, opposite end of said arm 215, said second coupler 225b also for releasable engagement with a container. The arm displacer 220 is configured to rotate the arm 215 with the first and the second couplers 225a, 225b about the vertical axis of rotation AR between a first and a second arm rotational position and to displace the arm 215 with the first and the second couplers 225a, 225b in a vertical direction between a first and a second vertical position.

By providing such a container handler 2 a compact container handling solution having comparably small footprint is achieved. Still with reference to FIG. 5, a constructionally simple container handler 2 is achieved with only a few moving parts. This also results in a robust and reliable solution being considerably less expensive than prior art solutions, such as robotic container transfer arms. Here, the constructional simplicity and robustness don't negatively impact the output capacity of the container handler.

In one embodiment, the arm displacer 220 is configured to rotate the arm 215 in the horizontal plane between the first and the second arm rotational position when the arm with the first and the second couplers 225a, 225b is in an upper vertical position.

The arm with the first and the second couplers 225a, 225b is arranged to reciprocate about the axis of rotation AR in order to avoid entanglement of power and control cables. In a preferred embodiment, an angular stroke of the reciprocal rotation is 180 degrees.

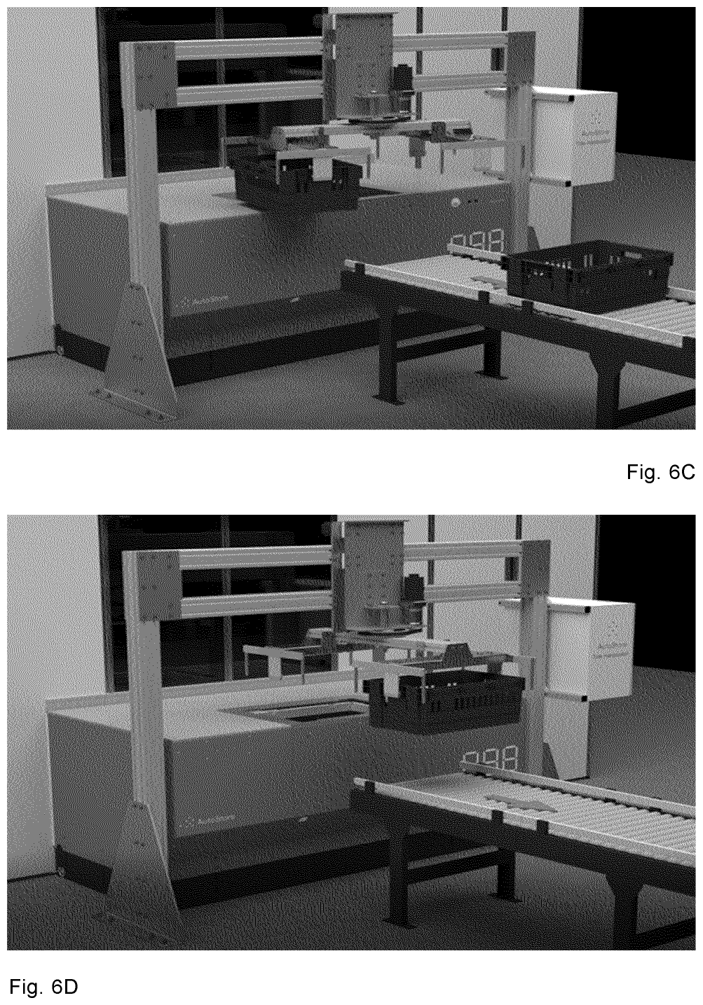

Still with reference to FIG. 5, the arm displacer 220 of the container handler 2 comprises a vertical displacement mechanism 230. The vertical displacement mechanism 230 comprises a vertically guiding part (232: shown in FIG. 6A) and a vertically displaceable support 234 slidably connected with the vertically guiding part. The arm 215 with the first and the second couplers 225a, 225b is attached to said support 234. A vertical displacement motor, for example a DC-motor (not visible in FIG. 5), displaces the support 234 with the attached arm 215 along the vertically guiding part.

In addition to the vertical displacement mechanism 230, the arm displacer 220 comprises a rotational displacement mechanism 240. The rotational displacement mechanism 240 comprises a rotational displacement motor 242 attached to the vertically displaceable support 234. The motor 242 rotates the arm 215 with the first and the second couplers 225a, 225b in the horizontal plane between the first and the second arm rotational position. The arm displacer 220, its parts and operation are more thoroughly discussed in connection with FIGS. 6A-6F.

In one embodiment, the container handler 2 comprises a movable weight (not shown) for counterbalancing vertical movement of the arm 215 with the first and the second couplers 225a, 225b.

FIGS. 6A-6F illustrate a repetitive operational sequence of the container handler 2 shown in FIGS. 4 and 5. References used in connection with previous FIGS. are used throughout the part of the description corresponding to FIGS. 6A-6F (although not featured in the FIGS. 6A-6F). Throughout the FIGS. 6A-6F, only one of the first and the second couplers 225a, 225b is in engagement with the container 20, 106 while said arm 215 is being vertically displaced or rotated. However, it is envisageable to displace/rotate the arm 215 while both couplers engage one container 20, 106 each.

In FIG. 6A, the arm 215 with a first and a second couplers 225a, 225b has been vertically lowered to a first, lower vertical position. The first coupler 225a is being engaged to a delivery container (tote) placed inside a storage container (bin) delivered by a carousel port 205. At the same time, the second coupler 225b is being disengaged from the delivery container. Generally, when the arm 215 is in the first, lower vertical position, engaging process of the first coupler 225a occurs simultaneously with the disengaging process of the second coupler 225b.

In FIG. 6B, the first coupler 225a is in engagement with the delivery container 20 whereas the second coupler 225b has released the delivery container on the conveyor belt 210. The arm 215 with the first and the second couplers 225a, 225b has been vertically hoisted to a second, upper vertical position. Said arm 215 is in a first arm rotational position. Generally, the arm 215 may only rotate between the first and the second rotational position when the arm is in the second, upper vertical position.

In FIG. 6C, the arm 215 with first and the second couplers 225a, 225b is being rotated in a horizontal plane between the first and a second arm rotational position. The first coupler 225a is still in engagement with the container.

In FIG. 6D, the rotational movement of the arm 215 is completed and the arm 215 is in the second arm rotational position. The first coupler 225a is still in engagement with the container. The arm 215, in particular the second coupler 225b, is aligned with a container tray of the carousel port 205.

In FIG. 6E, the arm 215 with the first and the second couplers 225a, 225b is being vertically lowered towards the first, lower vertical position. The first coupler 225a is still in engagement with the container.

In FIG. 6F, the arm 215 with the first and the second couplers 225a, 225b has reached the first, lower vertical position and the container is being disengaged from the first coupler 225a while the second coupler 225b is being engaged to the container positioned within another storage bin delivered by the carousel port 205.

In this context, the container handler 2 is versatile and may be employed in connection with different port types, such as, in addition to carousel ports, conveyor ports and swing ports, as well as different conveyor types, such as roller conveyors of FIG. 6A-6F or belt conveyors.

FIG. 7 is a perspective view of couplers 225a, 225b of a container handler, said couplers being attached to the previously discussed, rotatable and vertically displaceable arm 215. It is also shown a gear 216 mounted to upper face of said arm 215 for rotational motion of the arm 215 as described in connection with FIGS. 6A-6F.

The proximal coupler 225a is shown in engagement with a delivery container 20 partly enclosed by a storage container 106. Still with reference to the proximal coupler 225a, it comprises a coupler arm 258, arranged perpendicularly to said displaceable arm 215, a gripper assembly 260 provided at a periphery of the coupler arm 258, and an actuator system (not shown) operatively connected to the gripper assembly 260 to allow the gripper assembly 260 to releasably engage with the delivery container 20.

The actuator system of the coupler comprises a motor, an actuator control system configured to control operation of the motor, and a linkage interconnecting the motor and the gripper assembly. The motor may for example be a DC motor.

In one embodiment of the actuator system, the linkage of the actuator of each coupler 225a, 225b comprises a first link connecting the motor and a first gripper paddle ((being obscured by the tote 20 of FIG. 7)) of a first gripper element 265a and a second link connecting the motor and a gripper paddle 270b of the second gripper element 265b. The motor is configured to displace the first and second links such that horizontally displaceable gripper paddles 270a, 270b releasably engage with the container 20.

The gripper assembly 260 comprises two oppositely provided gripper elements 265a, 265b, each gripper element 265a, 265b comprising a horizontally extending gripper rod 266a, 266b arranged parallel to the arm 215, each gripper rod 266a, 266b being fixedly attached to an end of the coupler arm 258, abutment sensors 268a, 268b, 268c, 268d provided at each end of the gripper rod 266a, 266b, and a horizontally displaceable first and second gripper paddles 270a, 270b provided adjacent the gripper rod 266a, 266b, said gripper paddles 270a, 270b for effecting releasable engagement with the container 20.

The purpose of the abutment sensors 268a, 268b, 268c, 268d is to register abutment with a rim 22 of the tote 20. Abutment sensors may e.g. be mechanical sensors such as pressure activated sensors or electronical proximity sensors. In the former case, the extent of the tote abutment sensors should be such that it is ensured that the tote abutment sensors at contact exert pressure on the rim 22.

The horizontally displaceable gripper paddles 270a, 270b each comprise a horizontally extending protrusion 272a (its counterpart being obscured by the gripper paddle 270b of FIG. 7) at a lower end, a ledge, a rib or a fold, for exterior insertion into a corresponding recess or aperture 21 of the container 20.

The discussed coupler 225a is particularly configured to allow releasable engagement to a delivery container (tote) 20 placed in a storage container (bin) 106 arrangement. However, alternative configurations may be envisaged such as couplers adapted to allow releasable engagement with only the bin 106 and/or with both the tote 20 and the surrounding bin 106.

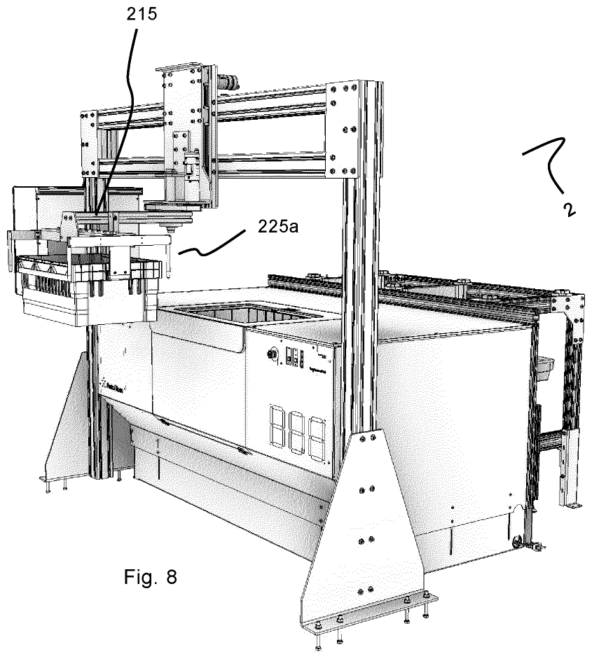

FIG. 8 is a perspective view of a container handler 2 in accordance with an alternative embodiment. The embodiment of FIG. 8 shows the container handler 2 for bidirectional transfer of containers. Only significant structural difference of the handler 2 of FIG. 8 when compared with the handler of FIGS. 4-6 is the absence of the second coupler, i.e. only a first coupler 225a is present. Further, the arm 215 is adapted to function in a single coupler configuration. For the sake of brevity, functioning and advantages discussed above in connection with the double coupler configuration may even be associated with the handler shown of FIG. 8 and are not further discussed.

In the preceding description, various aspects of the container handler for handling containers such as delivery containers (totes) and storage containers (bins), an automated storage and retrieval system comprising such a container handler and associated methods have been described with reference to the illustrative embodiments. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Automated storage and retrieval system
2 Container handler
3 Container handler operator
20 Delivery container/tote
21 Tote aperture
22 Tote rim
100 Framework structure
102 Upright members of framework structure
104 Storage grid
105 Storage column
106 Storage container/bin
106′ Particular position of storage container
107 Stack
108 Rail system
110 Parallel rails in first direction (X)
112 Access opening
119 Delivery port column
120 Receiving port column
200 Prior art central cavity container handling vehicle
201 Vehicle body of the container handling vehicle 200
202a Drive means/wheel arrangement/first set of wheels in first direction (X)
202b Drive means/wheel arrangement/second set of wheels in second direction (Y)
205 Port
210 Conveyor
215 Arm with axis of rotation
216 Gear
220 Arm displacer
225a First coupler
225b Second coupler
230 Vertical displacement mechanism
232 Vertically guiding part
234 Vertically displaceable support
240 Rotational displacement mechanism
242 Rotational displacement motor
250 Stand
252a Stand pillar
252b Stand pillar
253 Control cabinet
254 Crossbar
258 Coupler arm
260 Gripper assembly
265a First gripper element
265b Second gripper element
266a First gripper rod
266b Second gripper rod
268a First abutment sensor
268b Second abutment sensor
268c Third abutment sensor
268d Fourth abutment sensor
270a First gripper paddle
270b Second gripper paddle
272a First paddle protrusion
272b Second paddle protrusion
300 Prior art container handling vehicle
301 Vehicle body of the container handling vehicle 300
302a Drive means/first set of wheels in first direction (X)
302b Drive means/second set of wheels in second direction (Y)
400 Prior art container handling vehicle
401 Vehicle body of the container handling vehicle 401
402a Drive means/first set of wheels in first direction (X)
402b Drive means/second set of wheels in second direction (Y)
403 Lifting device
404 Gripper elements/claws for storage container 106
404a Lifting bands for storage container 106
405 Guiding pins for storage container 106
X First direction
Y Second direction
Z Third direction
AR Axis of rotation

1. A container handler for bidirectional transfer of containers between a port of a storage grid of an automated storage and retrieval system and a conveyor for transporting containers, said container handler comprising:
an arm having an axis of rotation,
an arm displacer,
at least a first coupler provided at a first end of said arm, said first coupler for releasable engagement with a container,
wherein the arm displacer is configured to:
rotate the arm about the axis of rotation with at least the first coupler held in a horizontal plane between a first and a second arm rotational position, and
displace the arm with at least the first coupler in a vertical direction between a first and a second vertical position.

2. The container handler in accordance with claim 1, wherein the arm displacer is configured to:
rotate the arm with at least the first coupler in the horizontal plane between the first and the second arm rotational position when the arm and at least the first coupler are in an upper vertical position.

3. The container handler in accordance with claim 1, the container handler comprising a second coupler provided at a second, opposite end of said arm, said second coupler for releasable engagement with a container.

4. The container handler in accordance with claim 3, wherein, when said arm is configured to be vertically displaced or rotated, only one of the first and the second couplers is in engagement with the container.

5. The container handler in accordance with claim 3, wherein the arm with the first and the second couplers is arranged to reciprocate about the axis of rotation.

6. The container handler in accordance with claim 5, wherein an angular stroke of the reciprocal rotation is 180 degrees.

7. The container handler in accordance with claim 1, wherein the arm displacer comprises:
a vertical displacement mechanism comprising:
a vertically guiding part;
a vertically displaceable support slidably connected with the vertically guiding part, the arm with at least the first coupler being fixedly attached to said support; and
a vertical displacement motor configured to displace the support with the attached arm along the vertically guiding part.

8. The container handler in accordance with claim 7, wherein the arm displacer comprises:
a rotational displacement mechanism comprising:
a rotational displacement motor attached to the vertically displaceable support and configured to rotate the arm with at least the first coupler in the horizontal plane between the first and the second arm rotational position.

9. The container handler in accordance with claim 1, wherein the container handler is arranged to be provided at an interface of the port of the storage grid of the automated storage and retrieval system and the conveyor for transporting containers.

10. The container handler in accordance with claim 1, wherein the container handler comprises a stand comprising two legs connected by a crossbar, wherein the arm displacer is connected to the crossbar.

11. The container handler in accordance with claim 10, wherein said stand is configured to straddle the port of the storage grid of the automated storage and retrieval system and/or the conveyor for transporting containers such that the arm of the container handler is aligned with a container tray of the port of the storage grid of the automated storage and retrieval system and/or the conveyor for transporting containers.

12. The container handler in accordance with claim 11, wherein the container tray associated with the port of the automated storage and retrieval system and the conveyor for transporting containers are provided at the same level.

13. The container handler in accordance with claim 1, wherein the port of the automated storage and retrieval system is a carousel port arranged to rotate substantially concurrently with the arm with at least the first coupler.

14. The container handler in accordance with claim 13, wherein the carousel port and the arm with at least the first coupler are arranged to rotate in opposite directions.

15. The container handler in accordance with claim 1, wherein the container handler comprises a movable weight for counterbalancing vertical movement of the arm with at least the first coupler.

16. The container handler in accordance with claim 1, wherein said container has a delivery container stored therein.

17. The container handler in accordance with claim 1, wherein the first coupler comprises
a coupler arm, arranged perpendicularly to the arm,
a gripper assembly provided at a periphery of the coupler arm, and an actuator system operatively connected to the gripper assembly to allow the gripper assembly to releasably engage with the container.

18. The container handler in accordance with claim 17, wherein the actuator system of the first coupler comprises
a rotational displacement motor,
an actuator control system configured to control operation of the rotational displacement motor, and
a linkage interconnecting the rotational displacement motor and the gripper assembly.

19. The container handler in accordance with claim 18, wherein the gripper assembly comprises two gripper elements arranged at opposite ends of the coupler arm, each gripper element of the two gripper elements comprising:
a horizontally extending gripper rod arranged parallel to the arm, said gripper rod being fixedly attached to an end of the coupler arm,
an abutment sensor provided at each end of the gripper rod,
a horizontally displaceable gripper paddle provided adjacent the gripper rod, said gripper paddle for releasable engagement with the container.

20. The container handler in accordance with claim 19, wherein the linkage of the actuator of the first coupler comprises:
a first link connecting the motor and a first gripper paddle of the first gripper element, and
a second link connecting the motor and a second gripper paddle of the second gripper element, wherein the motor is configured to displace the first and second links such that the horizontally displaceable gripper paddles releasably engage with the container.

21. The container handler in accordance with claim 19, wherein the horizontally displaceable gripper paddle comprises a horizontally extending protrusion for exterior insertion into a corresponding recess or aperture of the container.

22. An automated storage and retrieval system comprising:
a storage grid comprising a framework structure having a plurality of vertical upright members defining a plurality of storage columns for storing stacks of storage containers, wherein a rail system is arranged on the framework structure, the rail system comprising perpendicular rails, the intersections of which form a grid made up of grid cells, the rails defining access openings for a plurality of storage columns,
a remotely operated vehicle comprising drive means configured to travel along the rail system and a storage container lifting device for storing and retrieving storage containers through the grid openings, and
a container handler for bidirectional transfer of containers between a port of the storage grid of the automated storage and retrieval system and a conveyor for transporting containers.

23. An automated storage and retrieval system in accordance with claim 22, wherein at least one of the storage containers within the framework structure has a delivery container stored therein.

24. A method for handling a container by a container handler comprising an arm having an axis of rotation, an arm displacer, at least a first coupler provided at a first end of said arm, wherein the method comprises:
bidirectionally transferring a container between a port of an automated storage and retrieval system and a conveyor for transporting containers by manipulating the container by means of at least the first coupler, the transferring comprising vertically displacing the arm with the first coupler and rotating the arm with at least the first coupler about the rotational axis in a horizontal plane.

25. A method in accordance with claim 24 for handling a container by a container handler comprising an arm having an axis of rotation, an arm displacer, a first coupler provided at a first end of said arm and a second coupler provided at a second, opposite end of said arm, wherein the method comprises:
vertically lowering the arm with the first and the second couplers to a first vertical position,
engaging a container by means of one of the first and the second couplers,
vertically hoisting the arm with first and the second couplers and the engaged container to a second vertical position,
rotating the arm with first and the second couplers and the engaged container about the axis of rotation in a horizontal plane between a first and a second arm rotational position,
vertically lowering the arm with the first and the second couplers and the engaged container to the first vertical position, and
disengaging the container from the one of the first and the second couplers.

26. A method in accordance with claim 25, wherein steps of the method are performed sequentially.

27. A method in accordance with claim 26, wherein the method comprises:
disengaging the container from the one of the first and the second couplers while engaging another container with the other one of the first and the second couplers.

28. A method in accordance with claim 25, comprising the step of:
counterbalancing vertical movement of the arm with the first and the second couplers by means of a movable weight.

29. A method in accordance with claim 24, wherein the container to be handled is a delivery container (20) stored in a storage container (106) disposed in the port (205) of the automated storage and retrieval system (1).

30. A computer-readable medium having stored thereon a computer program for controlling a container handler, the container handler comprising an arm having an axis of rotation, an arm displacer, a first coupler provided at a first end of said arm and a second coupler provided at a second, opposite end of said arm, the computer program comprising instructions to execute:
vertically lowering the arm with the first and the second couplers to a first vertical position,
engaging a container by means of one of the first and the second couplers,
vertically hoisting the arm with first and the second couplers and the engaged container to a second vertical position,
rotating the arm with first and the second couplers and the engaged container about the axis of rotation in a horizontal plane between a first and a second arm rotational position,
vertically lowering the arm with the first and the second couplers and the engaged container to the first vertical position, and
disengaging the container from the one of the first and the second couplers.
